(19) United States
(12) Patent Application Publication
(10) Pub. No.: US 2026/0039762 A1
(43) Pub. Date: Feb. 5, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KOHEI SONODA, Kanagawa (JP)

(21) Appl. No.: 19/277,817

(22) Filed: Jul. 23, 2025

(30) Foreign Application Priority Data
Aug. 1, 2024 (JP) 2024-126029

(51) Int. Cl. H04N 1/32; H04N 1/00

(52) U.S. Cl. CPC H04N 1/32128; H04N 1/0097; H04N 2201/3278

(57) ABSTRACT

A method of controlling an information processing apparatus includes: performing a first control operation of performing control not to display a predetermined notification screen if a setting value set for a particular setting item is specified to be a first value but information on a device model of a communication apparatus is specified to be information corresponding to a second device model different from a first device model; and performing a second control operation of performing control to send a scan job not including information on the particular setting item to a communication apparatus selected as a sending destination based on a fact that a first operation is performed on the predetermined notification screen, and performing control not to send the scan job to the selected communication apparatus based on a fact that a second operation different from the first operation is performed on the predetermined notification screen.

### BACKGROUND

### Field of the Technology

The present disclosure relates a technique for sending a job to an image forming apparatus from an information processing apparatus.

### Description of the Related Art

In recent years, high-performance mobile terminals called smartphones have become widespread. In addition, such mobile terminals are provided with a function such as a scan function or a print function that cooperates with image forming apparatuses. For example, to execute a function to send a scanned document to a designated destination, a mobile terminal searches for an image forming apparatus on a local area network (LAN). The mobile terminal generates a sending job by using a destination email address and various scan setting information (e.g., color and double-side scan, etc.) set by the user. Then, the mobile terminal sends the generated sending job to an image forming apparatus with a sending function found by the search. In this way, the mobile terminal can instruct the image forming apparatus to execute a series of processes necessary for sending a scanned document. That is, while the image forming apparatus performs the actual scan process or print process, the mobile terminal can issue an instruction to execute it including various settings and the like.

Japanese Patent Laid-Open No. 2022-19049 (hereinafter referred to as Document 1) discloses a technique in which, in a case where an image forming apparatus executes a print job on a server in response to detecting an approach of an integrated circuit (IC) card, the image forming apparatus determines whether the print settings in that print job satisfy reference print conditions. Document 1 discloses that a predetermined warning is issued in a case where reference print conditions are not satisfied.

There is a need to improve usability in a case where an information processing apparatus causes a communication apparatus to execute a job.

### SUMMARY

A method of controlling an information processing apparatus according to an aspect of the present disclosure includes: performing a first specification operation of specifying a plurality of setting values set for a plurality of setting items related to a scan job for causing a communication apparatus to execute a scan; performing a second specification operation of specifying the setting value set for a particular setting item among the plurality of setting values; performing a third specification operation of specifying information on a device model of a communication apparatus selected as a destination to send the scan job; performing a first control operation of performing control to display a predetermined notification screen based on a fact that the setting value set for the particular setting item is specified to be a first value and the information on the device model of the communication apparatus is specified to be information corresponding to a first device model, and performing control not to display the predetermined notification screen in a case where the setting value set for the particular setting item is specified to be the first value but the information on the device model of the communication apparatus is specified to be information corresponding to a second device model different from the first device model; and performing a second control operation of performing control to send the scan job not including information on the particular setting item to the communication apparatus selected as the sending destination based on a fact that a first operation is performed on the predetermined notification screen, and performing control not to send the scan job to the communication apparatus selected as the sending destination based on a fact that a second operation different from the first operation is performed on the predetermined notification screen.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of an information processing system;

FIG. 2 is a diagram illustrating an example of a hardware configuration of an information processing apparatus;

FIG. 3 is a block diagram illustrating an example of a hardware configuration of an image forming apparatus;

FIG. 4 is a diagram illustrating an example of a software configuration of the information processing apparatus;

FIG. 5 is a diagram illustrating an example of a software configuration of the image forming apparatus;

FIGS. 6A and 6B are diagrams illustrating display screens of an application operating on the information processing apparatus;

FIGS. 7A and 7B are diagrams illustrating display screens of the application operating on the information processing apparatus;

FIGS. 8A and 8B are diagrams illustrating display screens of the application operating on the information processing apparatus;

FIGS. 9A and 9B are diagrams illustrating display screens of the application operating on the information processing apparatus;

FIG. 10 is a flowchart illustrating an example of processing for checking job settings in a case of sending job information;

FIG. 11 is a diagram showing the relationship of FIGS. 11A and 11B;

FIGS. 11A and 11B are totally a flowchart illustrating an example of processing for checking job settings in a case of sending job information;

FIGS. 12A to 12C are diagrams illustrating examples of a notification screen;

FIGS. 13A and 13B are diagrams illustrating an example of user setting screens for a “copy” function;

FIG. 14 is a diagram illustrating an example of a flowchart in a case where a “scan” function is pressed;

FIGS. 15A and 15B are diagrams illustrating examples of a job execution screen; and

FIG. 16 is a diagram illustrating an example of a flowchart in a case of where a press on a “scan” function is accepted.

### DESCRIPTION OF THE EMBODIMENTS

Embodiments of the present disclosure will now be specifically described below with reference to the accompanying drawings. Note that the following embodiments do not limit the contents of the present disclosure, and not all of the combinations of the features described in the following embodiments are necessarily essential for the solution to be provided by the present disclosure. Note that identical constituent elements are denoted by the same reference numeral.

### First Embodiment

### <General Description>

A first embodiment will describe a configuration that utilizes an application program (hereinafter referred to simply as “application”) to be used by a mobile terminal, such as a smartphone or a tablet terminal. This application will be referred to as “mobile app.” The mobile app has a function to communicate with an image forming apparatus, such as a multifunction peripheral (MFP), and send jobs to the image forming apparatus. A “job” includes various setting items, and the user can set the setting values of the setting items.

The mobile app is provided with a function which, in a case of using image forming apparatuses at different locations, allows the user to send jobs using the same setting values to the image forming apparatuses. For example, the user sets a first setting value for a first setting item and saves this setting as a favorite. Whether the user uses an image forming apparatus installed at a first location or an image forming apparatus installed at a second location, the user can send a job in which the setting value registered as the favorite is reflected to the image forming apparatus through the mobile app. Using this favorite function eliminates the need to individually set a setting value for each image forming apparatus and thus improves user friendliness. Note that there can be multiple setting items, and there can also be multiple settable setting values for each of the setting items. That is, a “favorite” is a saved combination of setting values of setting items.

Here, image forming apparatuses may have, for example, different platforms, which makes some image forming apparatuses unable to reflect the first setting value set for the first setting item in a job in the execution of the job. Specifically, with a first image forming apparatus having a first platform, the first setting value set for the first setting item in a job will not be reflected in the execution of the job by the first image forming apparatus. On the other hand, with a second image forming apparatus having a second platform, the first setting value set for the first setting item in a job will be reflected in the execution of the job by the second image forming apparatus. In this case, the first image forming apparatus executes the job in which a second setting value, which is a setting value complying with a predetermined rule for the first image forming apparatus, is set instead of the first setting value set by the user. For this reason, in the case of using the first image forming apparatus, the user may realize after the job is executed that the job was not executed with the setting value which the user set themselves. This may confuse the user. Incidentally, it is conceivable to employ a countermeasure that prohibits sending of a job to the first image forming apparatus due to the fact that the first image forming apparatus does not reflect the first setting value in the job. Such a countermeasure, however, may lower user friendliness. This is because the user may think that executing the job with the second setting value, instead of the first setting value, with the first image forming apparatus is acceptable, for example.

The present embodiment will describe an example of improving usability in a case where an information processing apparatus causes an image forming apparatus (communication apparatus) to execute a job. For example, even in a case where the first setting value set for the first setting item in a job will not be reflected with an image forming apparatus selected as a sending destination, the job is made executable in a case where the user thinks that executing the job is acceptable. That is, in a case where the first setting value will not be reflected with the image forming apparatus selected as the sending destination, a notification screen which notifies the user of that fact and is capable of accepting an instruction to execute the job is displayed on the information processing apparatus. Then, in response to accepting an instruction to execute to the job, the information processing apparatus sends the job to the image forming apparatus even though the first setting value is set. The present embodiment will now be specifically described below.

### <Configurations>

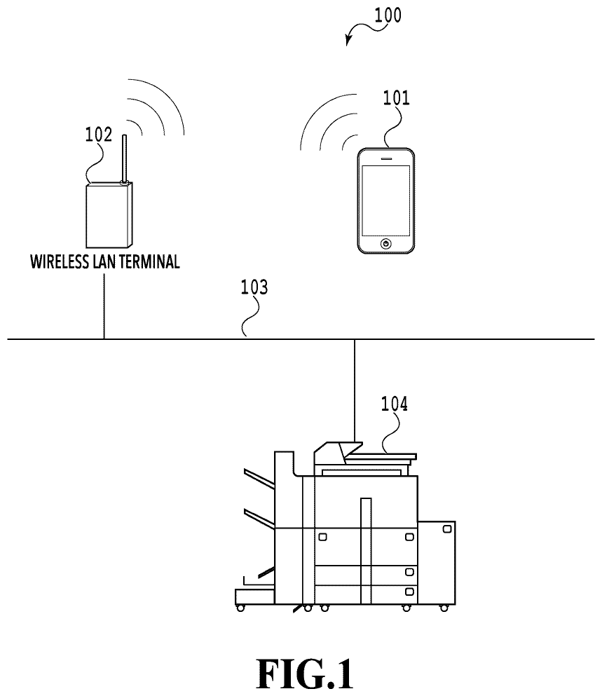

FIG. 1 is a diagram illustrating an example of a configuration of an information processing system according to the present embodiment. An information processing system 100 has an information processing apparatus 101, a wireless LAN terminal 102, and an image forming apparatus 104. These apparatuses are connected through a network 103, such as a LAN. Apparatuses other than those illustrated in the diagram may be connected to the network 103.

The information processing apparatus 101 is a mobile terminal, such as a smartphone or a tablet. An operating system for a small terminal and programs that control voice calls, location detection, and data communication may operate on the information processing apparatus 101. Alternatively, the information processing apparatus 101 may be a personal computer (PC) that does not perform audio control, location detection control, mobile phone data communication, or the like. The information processing apparatus 101 is connected to the network 103 by the wireless LAN terminal 102.

The wireless LAN terminal 102 is a wireless LAN base unit having general network and router functions, and provides wireless network communication through a wireless LAN inside a house, an office, or the like.

The image forming apparatus 104 is a digital multifunction peripheral equipped with various job execution functions, such as a printer function, a copy function, a scanner function, and a fax sending function. However, the image forming apparatus 104 is not limited to this and may be an apparatus having a single function. The image forming apparatus 104 may be configured to incorporate a wireless access point and to be capable of directly communicating with the information processing apparatus 101 without going through the wireless LAN terminal 102. The user can operate the information processing apparatus 101 to instruct the image forming apparatus 104 to execute jobs and output instructions to execute various functions of the image forming apparatus 104 through the information processing apparatus 101. The image forming apparatus 104 is a communication apparatus that communicates with the information processing apparatus 101.

Note that, in the present embodiment, the image forming apparatus 104 is configured to be connected to the network 103 via a wired connection, but the image forming apparatus 104 may be wirelessly connected to the network 103 using the wireless LAN terminal 102, as with the information processing apparatus 101. Further, the information processing apparatus 101 and the image forming apparatus 104 are capable of short-range wireless communication using wireless signals, such as near-field communication (NFC) or Bluetooth Low Energy (BLE). The image forming apparatus 104 has connection information for establishing a wireless LAN connection with the image forming apparatus 104 (the Internet Protocol (IP) address, a media access control (MAC) address, or the like) and is capable of sending the connection information to the information processing apparatus 101 through an NFC communication unit or BLE communication unit to be described later. The information processing apparatus 101 is capable of starting wireless LAN communication with the image forming apparatus 104 using the obtained connection information.

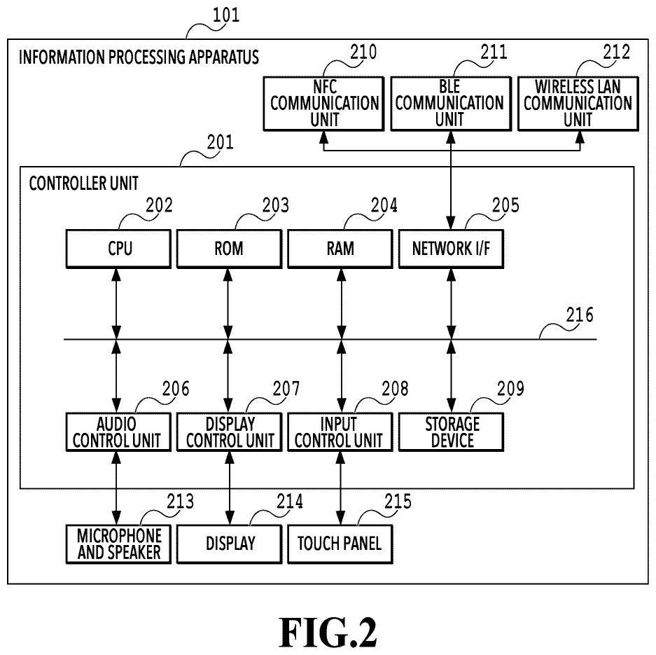

FIG. 2 is a diagram illustrating an example of a hardware configuration of the information processing apparatus 101 according to the present embodiment. The information processing apparatus 101 has a controller unit 201, an NFC communication unit 210, a BLE communication unit 211, a wireless LAN communication unit 212, a microphone and speaker 213, a display 214, and a touch panel 215. The controller unit 201 controls various communications units, such as the NFC communication unit 210, the BLE communication unit 211, and the wireless LAN communication unit 212, and various user interface (UI) units, such as the microphone and speaker 213, the display 214, and the touch panel 215.

The controller unit 201 has a central processing unit (CPU) 202, a read-only memory (ROM) 203, a random-access memory (RAM) 204, a network interface (I/F) 205, an audio control unit 206, a display control unit 207, an input control unit 208, and a storage device 209. The components of the controller unit 201 are connected by a system bus 216.

The CPU 202 controls the entire system of the information processing apparatus 101. The ROM 203 stores the operating system of the information processing apparatus 101 and programs that controls calls and data communication. The CPU 202 executes these various programs. The RAM 204 is a main memory for the CPU 202, and is used as a temporary storage area such as a work area. The storage device 209 is a non-volatile storage device and stores various operating mode settings, operation logs, and the like that need to be held also after the information processing apparatus 101 is reactivated.

The network I/F 205 is connected to the NFC communication unit 210, the BLE communication unit 211, and the wireless LAN communication unit 212 and exchanges data with the image forming apparatus 104 through various types of wireless communication.

The audio control unit 206 controls input and output of audio data through the microphone and speaker 213. The display control unit 207 controls output of image data to be displayed on the display 214. The input control unit 208 controls input of information designated by the user with buttons or the touch panel 215. Various applications to be executed by the information processing apparatus 101 use these audio control unit 206, display control unit 207, and input control unit 208 and so on.

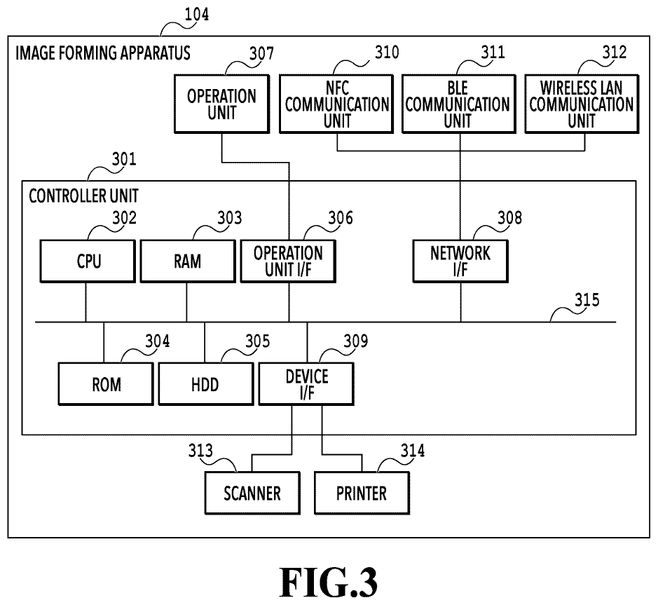

FIG. 3 is a block diagram illustrating an example of a hardware configuration of the image forming apparatus 104 according to the present embodiment. The image forming apparatus 104 has a controller unit 301, an operation unit 307, an NFC communication unit 310, a BLE communication unit 311, a wireless LAN communication unit 312, a scanner 313, and a printer 314. The controller unit 301 controls various communication units, such as the NFC communication unit 310, the BLE communication unit 311, and the wireless LAN communication unit 312, the operation unit 307, the scanner 313, and the printer 314.

In a case where the user uses the copy function of the image forming apparatus 104, the controller unit 301 controls the scanner 313 to obtain image data of a document, and controls the printer 314 to print an image onto a sheet and output it. Also, in a case where the user uses a “scan and send” function, the controller unit 301 controls the scanner 313 to obtain image data of a document and converts it into code data. The controller unit 301 then sends the converted data to the information processing apparatus 101 or the like through a network I/F 308. Also, in a case where the user uses the print function, the controller unit 301 receives image data (code data) from the information processing apparatus 101 through the network I/F 308. The controller unit 301 then sends the received image data to the printer 314. The printer 314 prints an image onto a sheet based on the received image data and outputs the sheet. Also, the image forming apparatus 104 has a fax receiving function to receive data from Integrated Services Digital Network (ISDN) or the like and print it, and a fax sending function to data obtained by scanning to ISDN or the like. A task to be processed for which the user has configured settings or the like in order to execute any of functions as described above will be referred to as “job.” The image forming apparatus 104 executes a predetermined job in accordance with information including the job (hereinafter referred to as “job information”).

The controller unit 301 has a CPU 302, a RAM 303, a ROM 304, a hard disk drive (HDD) 305, an operation unit I/F 306, the network I/F 308, and a device I/F 309. The components included in the controller unit 301 are connected by a system bus 315.

The CPU 302 controls the entire system of the image forming apparatus 104. The RAM 303 is a system work memory for the operation of the CPU 302, and temporarily stores image data and the like. The RAM 303 stores scan image data obtained by reading with the scanner 313 and print image data received from the information processing apparatus 101 through the network 103. The ROM 304 stores a system boot program, applications, and the like. The HDD 305 stores an operating system, system software, application software, image data, setting data, and the like.

The operation unit 307 displays information to the user and accepts operations from the user. For example, an operation panel, such as a touch panel display, is used as the operation unit 307.

The operation unit I/F 306 outputs information to be displayed on the operation unit 307 to the operation unit 307. Also, the operation unit I/F 306 accepts information input by the user through the operation unit 307. The network I/F 308 is connected to the NFC communication unit 310, the BLE communication unit 311, and the wireless LAN communication unit 312 and exchanges information with the information processing apparatus 101 and a cloud server (not illustrated) through various types of communication. The wireless LAN communication unit 312 performs wireless LAN communication with the information processing apparatus 101 through the network 103. The NFC communication unit 310 and the BLE communication unit 311 each perform short-range wireless communication with the information processing apparatus 101. The image forming apparatus 104 receives job information including job setting information, image data, a job execution command, and the like from the information processing apparatus 101 through the network I/F 308 and executes a job. The device I/F 309 connects the controller unit 301 to the scanner 313, which reads image data, and the printer 314, which executes printing, and receives and outputs image data.

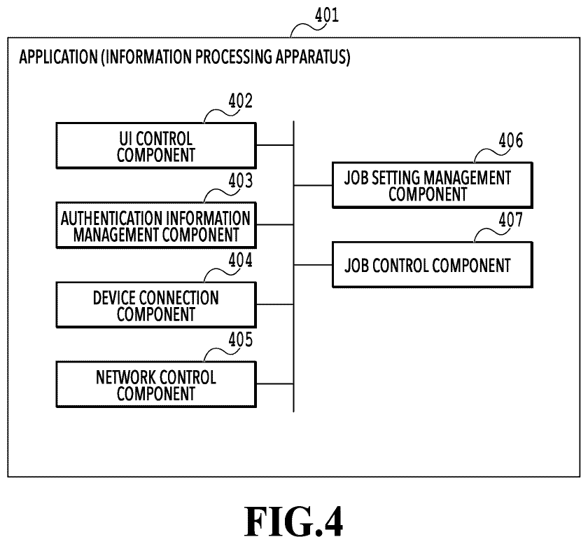

FIG. 4 is a diagram illustrating an example of a software configuration of the information processing apparatus 101 according to the present embodiment. FIG. 4 is a functional block diagram of software which the CPU 202 of the information processing apparatus 101 implements by reading out a control program (application) stored in the ROM 203 or the storage device 209.

An application 401 is an application installed in the information processing apparatus 101 and is an application for causing the image forming apparatus 104 to operate. The application 401 is the mobile app described earlier. The user configures settings on the application 401 and inputs an instruction that causes the application 401 to generate print job information, scan job information, or the like. The application 401 generates job information in accordance with this instruction. The application 401 is capable of sending the generated job information to the image forming apparatus 104. While various applications other than the application 401 are installed in the information processing apparatus 101, their description is omitted. A configuration of the application 401 will now be described below.

The application 401 has a UI control component 402, an authentication information management component 403, a device connection component 404, a network control component 405, a job setting management component 406, and a job control component 407.

The UI control component 402 accepts job setting information input by the user on the touch panel 215 and sends the accepted contents to the job setting management component 406 or the job control component 407 through the input control unit 208. The UI control component 402 receives a response from the job setting management component 406 or the job control component 407 and outputs a screen corresponding to the received contents to the display 214 through the display control unit 207. The UI control component 402 accepts authentication information input by the user on the touch panel 215 and sends it to the authentication information management component 403 through the input control unit 208.

The authentication information management component 403 saves and manages the authentication information received from the UI control component 402, such as user information. Then, the authentication information management component 403 performs a process of logging in to the image forming apparatus 104 based on the saved authentication information. Specifically, the authentication information management component 403 passes the authentication information to the network control component 405. That authentication information is sent to the image forming apparatus 104 through the network 103. The image forming apparatus 104 performs a login process using the received authentication information, and returns the result to the information processing apparatus 101. As described above, the application 401 can provide the authentication information saved and managed in the image forming apparatus 104 when the application 401 sends job information.

The device connection component 404 establishes, for example, short-range wireless communication using NFC or BLE or wireless LAN communication through the network 103 between the information processing apparatus 101 and the image forming apparatus 104. For example, with NFC, the user brings the NFC communication unit 210 of the information processing apparatus 101 close to the NFC communication unit 310 of the image forming apparatus 104 to start short-range wireless communication. With BLE, the BLE communication unit 311 of the image forming apparatus 104 sends a BLE beacon, and the BLE communication unit 211 of the information processing apparatus 101 receives the sent beacon. As the user brings the information processing apparatus 101 close to the image forming apparatus 104, the information processing apparatus 101 determines that the signal strength of the received beacon has reached or exceeded a certain level, in response to which short-range wireless communication is started. As described above, in response to the user bringing the NFC or BLE communication units of the information processing apparatus 101 and the image forming apparatus 104 close to each other, the device connection component 404 performs short-range wireless communication with the image forming apparatus 104. Then, through the short-range wireless communication, the device connection component 404 obtains apparatus information including connection information necessary for wireless LAN communication from the image forming apparatus 104. The connection information includes, for example, the IP address, the MAC address, or the like, as mentioned earlier, and also information such as the SSID and passkey of the wireless LAN to which the image forming apparatus 104 is connected. The device connection component 404 is capable of starting wireless LAN communication with the image forming apparatus 104 through the network 103 by using the connection information thus obtained. Note that the described method of obtaining the connection information is a mere example, and the method is not limited to this. For example, the device connection component 404 may use connection information input by the user through the touch panel 215 to establish a wireless LAN connection with the image forming apparatus 104.

The network control component 405 sends job information (information including job setting information, a job execution command, image data, user authentication information, and the like) to the image forming apparatus 104 through the network 103. In the present embodiment, the job information is sent to the image forming apparatus 104 through the wireless LAN terminal 102. For example, in a case where the job information to be sent is information on a job to send scan image data to a set destination, the job setting information includes the destination to send the data and the setting values of setting items related to the scan. The network control component 405 is also capable of receiving job setting information and the like stored in the image forming apparatus 104 through the network 103.

The job setting management component 406 stores the job setting information input by the user and accepted by the UI control component 402 and the job setting information received from the image forming apparatus 104 through the network control component 405 in the RAM 204 or the storage device 209. The job setting management component 406 may register each of these pieces of job setting information as “favorite” as a setting which the user frequently uses. Also, the job setting management component 406 may register job setting information stored in the RAM 204 or the storage device 209 at the time of installing the application 401 as “preset.”

The job control component 407 controls processes executed by the image forming apparatus 104. For example, the job control component 407 generates job information from job setting information included as “favorite” or “preset” registered by the job setting management component 406 or job setting information set by a user operation. Then, the job control component 407 sends the generated job information to the image forming apparatus 104 through the network 103 to thereby send a job execution instruction to the image forming apparatus 104. Also, the job control component 407 obtains the job execution status or the operating status of the device, i.e., namely, the scanner 313 or the printer 314, from the image forming apparatus 104 through the network 103 and sends it to the UI control component 402.

As described above, the application 401 is capable of generating job information and sending the generated job information to the image forming apparatus 104. Here, assume that the image forming apparatus 104 in the present embodiment includes a first image forming apparatus having a first platform and a second image forming apparatus having a second platform. A “platform” can include both a software platform and a hardware platform, for example. Assume also that the image forming apparatus 104 in the present embodiment includes a third image forming apparatus having a printing engine different from the printing engines of the first and second image forming apparatuses. The printing engines of the first and second image forming apparatuses are an electrophotographic type while the printing engine of the third image forming apparatus is an inkjet type.

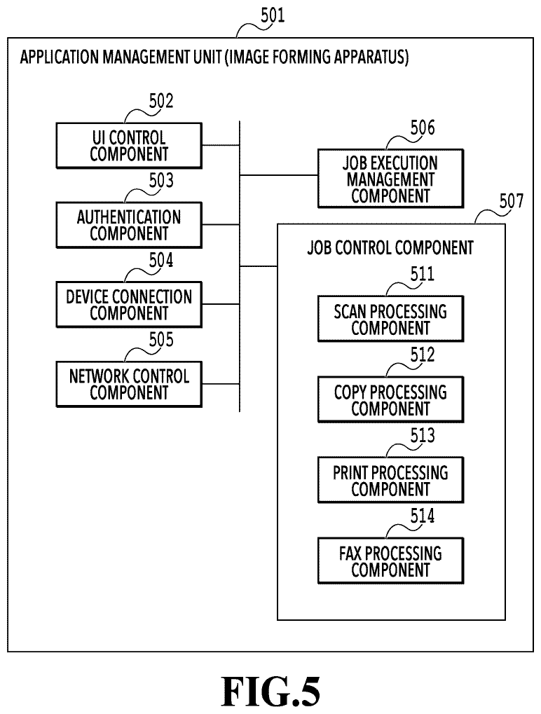

FIG. 5 is a diagram illustrating an example of a software configuration of the image forming apparatus 104 according to the present embodiment. FIG. 5 is a functional block diagram of software which the CPU 302 implements by reading out a control program stored in the ROM 304 or the HDD 305.

An application management unit 501 manages applications that operate on the image forming apparatus 104. The application management unit 501 has a UI control component 502, an authentication component 503, a device connection component 504, a network control component 505, a job execution management component 506, and a job control component 507. The job control component 507 has a scan processing component 511, a copy processing component 512, a print processing component 513, and a fax processing component 514.

The UI control component 502 accepts job setting information and the like input by the user through the operation unit 307 and passes them to the job execution management component 506 or the job control component 507. Also, the UI control component 502 receives a response from the job execution management component 506 or the job control component 507 and outputs a screen that is based on the response to the operation unit 307.

The authentication component 503 performs a login process based on authentication information received from the information processing apparatus 101 and returns the result of that process. The device connection component 504 establishes, for example, wireless LAN communication with the information processing apparatus 101. The network control component 505 receives job information including job setting information, a job execution command, image data, user authentication information, and the like from the information processing apparatus 101 through the network 103. The network control component 505 sends job setting information stored in the image forming apparatus 104 to the information processing apparatus 101 through the network 103.

The job execution management component 506 manages the status of jobs to be executed and the like. Also, the job execution management component 506 stores, in the RAM 204 or the storage device 209, pieces of job information including the job setting information input by the user through the UI control component 502, and pieces of the job setting information received by the network control component 505 from the information processing apparatus 101. The job execution management component 506 may register each of these pieces of job setting information as “favorite” as a setting which the user frequently uses. Also, the job execution management component 506 may manage a customized job setting stored in the RAM 204 or the storage device 209 at the time of installing the application as “preset.” Also, the job execution management component 506 is capable of managing jobs executed by the image forming apparatus 104 as “history.”

The job control component 507 controls the scan processing component 511, the copy processing component 512, the print processing component 513, and the fax processing component 514 in accordance with received job information and executes a corresponding job. For example, the job control component 507 executes a job using job setting information set by the user on the operation unit 307 or job setting information registered as “favorite” or “preset” by the job execution management component 506. Further, the job control component 507 receives a job execution request including job information received from the information processing apparatus 101 or the like through the network 103 and executes a corresponding job based on the received job setting information and a job execution instruction. Also, the job control component 507 sends the job execution status and the operating status of the device, namely, the scanner 313 or the printer 314, to the information processing apparatus 101 through the network 103.

### <Description of Application>

Details of the application 401, which is executed by the information processing apparatus 101, will now be described. Prior to configuring various settings, the application 401 performs a process of registering a communication apparatus being an apparatus to communicate with (the image forming apparatus 104 in the present embodiment) in the application 401.

In the present embodiment, the application 401 can obtain information on the communication apparatus (image forming apparatus 104) from that communication apparatus to register the communication apparatus in the application 401. The information on the communication apparatus is, for example, capability information (ability information) of the communication apparatus, identification information (such as the MAC address) of the communication apparatus, device model information of the communication apparatus, and the like. In particular, the capability information of the communication apparatus includes a list of information on functions supported by the communication apparatus, information on consumables that can be used by the communication apparatus (inks and sheets), information indicating the printing type of the communication apparatus, and the like.

The application 401 is capable of registering multiple communication apparatuses. As mentioned earlier, the user is expected to bring the information processing apparatus 101 and move to various locations, and communication apparatuses (image forming apparatuses) which the user is likely to use are registered in the application 401 based on user operations.

The application 401 selects one apparatus for the application 401 to communicate with from among the one or more communication apparatuses registered in the application 401. In the following, the communication apparatus currently selected as an apparatus for the application 401 to communicate with will be referred to as “selected communication apparatus.” Note that the apparatus for the application 401 to communicate with may be selected by accepting the user's selection from among the one or more communication apparatuses registered in the application 401. Alternatively, the application 401 may automatically select the apparatus for the application 401 to communicate with based on predetermined criteria. Also, the apparatus for the application 401 to communicate with may be changed by, for example, accepting the user's selection from among the one or more communication apparatuses registered in the application 401. In the present embodiment, the application 401 sends various jobs, such as a print job and a scan job, to the selected communication apparatus. That is, the selected communication apparatus is an apparatus to which to send various jobs.

The application 401 is configured to be capable of accepting a “favorite” setting as mentioned above in a state where any communication apparatus is selected. The “favorite” setting is a setting in which the user can set the setting value of each setting item of jobs, as described earlier, and may be referred to as “user setting.”

In the application 401 in the present embodiment, some of multiple functions supported by the application 401 support the “favorite” function. Specifically, three functions “scan and email,” function, “fax,” and “copy” are functions for which a “favorite” setting can be configured. In the present embodiment, the functions for which a “favorite” setting can be configured will be referred to as “particular functions.” Specifically, the particular functions include the three functions of “scan and email,” “fax,” and “copy.” The application 401 is configured such that the user can set the setting value of each setting item to any value for these particular functions regardless of the communication apparatus' ability. For the functions other than these particular functions, on the other hand, the application 401 is configured to be capable of accepting, from the user, only setting values that correspond to the ability information obtained from the communication apparatus. As an example, a description will now be given based on an example in which the application 401 executes a “print” function, which is a function other than the particular functions, to send a print job to a communication apparatus (image forming apparatus 104). The application 401 obtains the ability information of the selected communication apparatus from that communication apparatus. Assume, for example, that the application 401 obtains information from the selected communication apparatus indicating that it is an apparatus supporting color printing and not supporting double-side printing. In this case, the application 401 presents “monochrome” and “color” as options for the setting value of a setting item related to color printing. Also, the application 401 presents only “one-side printing” as the setting value of a setting item related to double-side printing. As described above, the application 401 is configured to be capable of accepting only setting values that correspond to the ability information obtained from the communication apparatus for the functions other than the particular functions.

On the other hand, “favorite” settings are settings common to the communication apparatuses. Thus, the application 401 is configured to be capable of accepting designation of the setting value of each setting item by the user that is not based on the ability information of the communication apparatus. For this reason, in a case where a set setting value is a setting value not supported by the communication apparatus, sending the job to the communication apparatus may cause a discrepancy. In the following, a description will be given of various processes to be performed in a case of configuring a “favorite” setting for one of the particular functions (in particular the “scan and email” function, hereinafter referred to as “first function”).

Note that the particular functions are functions that are displayed on the application 401 in a case where an electrophotographic image forming apparatus is the selected communication apparatus. The particular functions are functions that are not displayed on the application 401 in a case where an inkjet image forming apparatus is the selected communication apparatus.

### <Display Screens of Application>

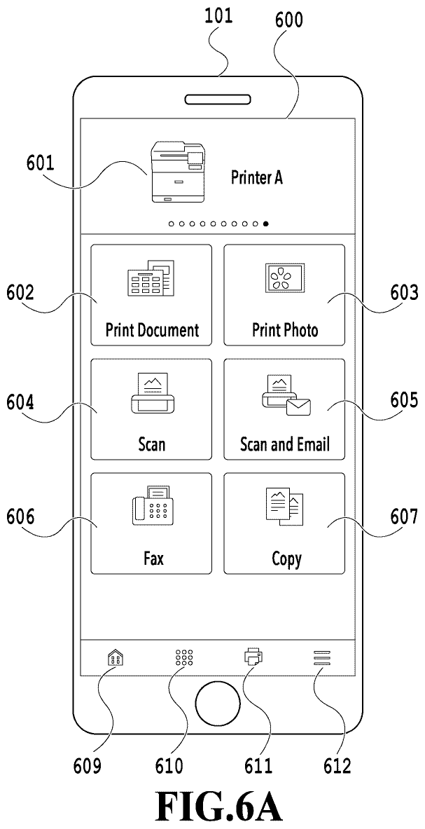

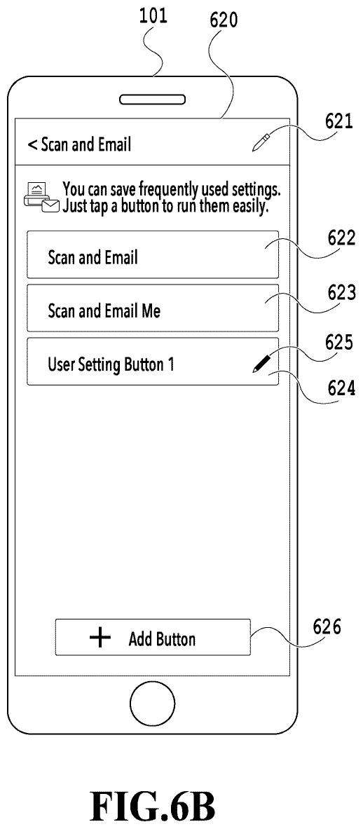

FIGS. 6A and 6B, FIGS. 7A and 7B, FIGS. 8A and 8B, and FIGS. 9A and 9B are diagrams illustrating display screens of the application 401 operating on the information processing apparatus 101. Processing performed by the application 401 on the information processing apparatus 101 will now be described using FIGS. 6A to 9B.

FIG. 6A is a menu screen (home screen) of the application 401 operating on the information processing apparatus 101. The application 401 is capable of communicating with the image forming apparatus 104 and issuing an instruction to execute a process to the image forming apparatus 104 using the contents of settings configured on the application. Note that, at a point before displaying the home screen in FIG. 6A, the information processing apparatus 101 has already established communication with the image forming apparatus 104 based on connection information obtained therefrom and the image forming apparatus 104 has already been registered. The home screen in FIG. 6A is in a state where an image forming apparatus “Printer A” has been selected as the image forming apparatus 104 as the sending destination. That is, in the example of FIG. 6A, the selected communication apparatus is Printer A.

On a home screen 600 of the application 401, the UI control component 402 displays identification information 601 of the selected image forming apparatus and functions that are available with the selected image forming apparatus (functions 602 to 607 in FIG. 6A). The application 401 is capable of switching the display screen by accepting pressing of buttons 609 to 612 in FIG. 6A. The “home” button 609 is a button for switching the display to the home screen 600. The “function list” button 610 is a button for switching the display to a screen (not illustrated) which lists all functions that can be used on the selected image forming apparatus. The “register/switch” button 611 is a button for switching the display to a screen (not illustrated) on which new image forming apparatuses can be registered in the application 401 and the selected image forming apparatus can be switched to a registered image forming apparatus, for example. The “menu” button 612 is a button for switching the display to a screen on which information on the application can be checked and settings of the application can be changed.

Of the functions displayed on the home screen 600, the “Scan” function 604 is a function to set up a job for the selected image forming apparatus and cause the image forming apparatus to perform a scan on a per-job basis. The “Scan” function 604 is a function to, after the image forming apparatus executes the scan, send a file obtained by the scan to the application 401 from the image forming apparatus and display the scan result on the application 401. Also, the “Scan and Email” function 605 is a function to execute a scan using setting information saved in the information processing apparatus in advance, and send an email to which the scan result is attached in the form of a file to a designated destination. The “Scan” function 604 and the “Scan and Email” function 605 are both functions for executing a scan job but differ in the method of sending the data obtained by the scan, as described above. Further, as mentioned earlier, the “Scan” function 604 is a function other than the particular functions while the “Scan and Email” function 605 is a particular function. The two functions are common from the perspective that both represent jobs which cause the image forming apparatus to execute a scan, but are different in that one is a particular function and the other is a function other than the particular functions. Also, the two functions are different also in the output destination of the job result.

In response to accepting a press on the “Scan and Email” function 605 by the user, the application 401 transitions to a screen listing registered (saved) job settings (FIG. 6B). Note that “press” is used herein as a term including touching through the touch panel 215. A screen 620 in FIG. 6B displays three registered job settings in the form of buttons, but this is an example. The display method, including the number of registered job settings to be displayed and the display names, may be different from that in the example of FIG. 6B. A “Scan and Email” button 622 and a “Scan and Email Me” button 623 are job settings registered as presets. For the “Scan and Email Me” button 623, the user's email address is set as the emailing destination. A “User Setting Button 1” 624 is a job setting including job setting values customized and registered in the application 401 by the user. The user can press a setting edit button 625 displayed on a right portion of the “User Setting Button 1” 624 to change the setting values of a registered job setting. The user can press an add button 626 to additionally register a job setting with customized setting values (“favorite” setting) in the application 401. The application 401 is capable of, for example, changing the order of the listed job settings and deleting registered job settings from the application 401 in a case of accepting a press on an edit button 621. Note that the job settings registered as presets cannot be deleted.

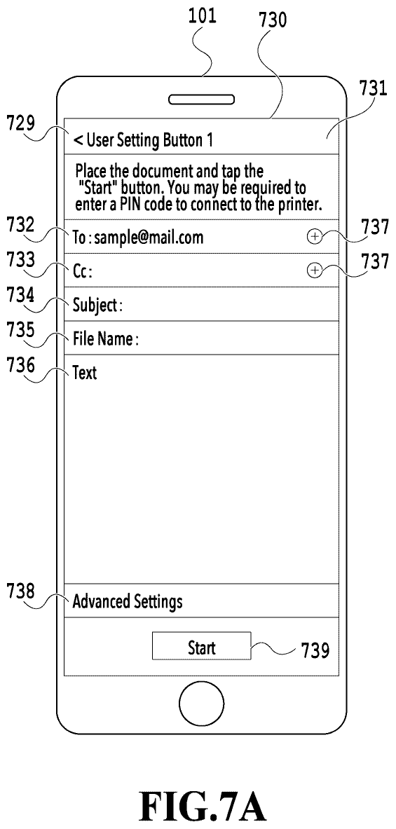

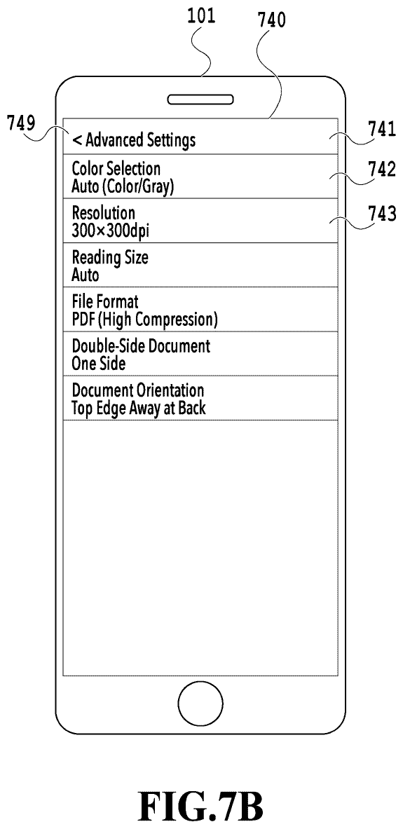

FIG. 7A illustrates an example of a screen for executing the “Scan and Email” function 605. FIG. 7A is a screen that is displayed in response to a press on the “User Setting Button 1” 624 by the user.

A “scan and email” execution screen 730 illustrated in FIG. 7A is a screen for configuring settings for emailing a scan image. In a title region 731, a title representing a setting screen (in this example “User Setting Button 1”) is displayed, and a button 729 for canceling the settings and returning to the menu screen is arranged as well. Email address setting regions 732 and 733 are regions which displays set email addresses. The user can press these regions to directly input sending destination email addresses with a software keyboard. Pressing an address book launch button 737 calls an address book inside the information processing apparatus 101. In response to accepting selection of an email address from the called address book by the user, the selected email address is displayed in the corresponding one of the email address setting regions 732 and 733. Multiple email addresses can be set.

A subject field 734 to input a subject, a file name input field 735, and a text field 736 to input text can accept input of any character strings by the user with the software keyboard of the information processing apparatus 101. A start button 739 is a button for sending job information to the image forming apparatus 104. Note that, when the start button 739 is pressed, the application 401 may confirm with the user whether the set email address is the address intended by the user, and then send the job information to the image forming apparatus 104.

An advanced setting button 738 is a button for configuring advanced scan settings, and the screen transitions to an advanced setting screen 740 illustrated in FIG. 7B in response to a press on the button. The advanced setting screen 740 includes a title region 741, in which a title is displayed and a button 749 for confirming the settings and returning to the “scan and email” execution screen 730 is arranged as well. The advanced setting screen 740 includes buttons corresponding to various setting items related to scanning (e.g., a color setting button 742). In a case where the user presses any of these buttons, the advanced setting screen 740 can accept designation of a corresponding setting value. For example, in response to a press on the color setting button 742, the screen transitions to a color setting screen (not illustrated) on which the setting item, or a color setting, can be changed, and the setting value set on the color setting screen is displayed on the corresponding button. In the example of FIG. 7B, the color setting button 742 represents a state where a setting value “Auto (Color/Gray)” is set. A resolution setting button 743 is configured such that the resolution at which the image forming apparatus executes a scan can be set as a setting value. In the example of FIG. 7B, a setting value “300×300 dpi” is set with the resolution setting button 743. Note that, as mentioned earlier, user settings (favorite settings) are settings for causing any image forming apparatus supporting the “scan and email” function to execute jobs registered in the information processing apparatus. Thus, the setting values that can be set for the setting items displayed on the advanced setting screen 740 are general setting values. That is, the user can designate these general setting values regardless of whether the selected image forming apparatus can implement these setting values.

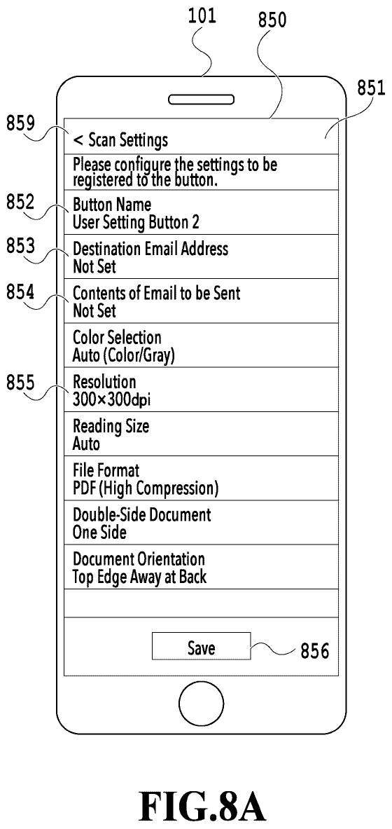

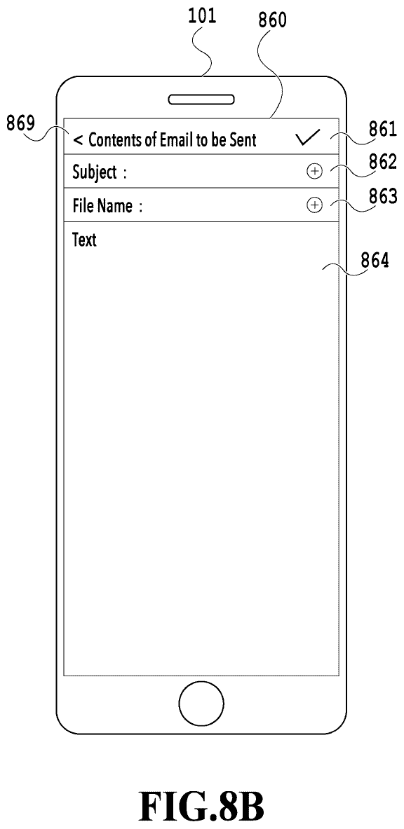

FIG. 8A illustrates a registration screen 850 for registering a new user setting (favorite setting) that is displayed in response to accepting a press on the add button 626 on the screen 620 in FIG. 6B. The registration screen 850 includes a title region 851, in which a title is displayed and a button 859 for canceling the settings and returning to the screen 620 is arranged as well. The registration screen 850 displays buttons corresponding to various setting items like the advanced setting screen 740 described with reference to FIG. 7B. For example, a resolution setting button 855 is included as a setting item, like the advanced setting screen 740 in FIG. 7B. In FIG. 8A, there are setting items whose setting values have already been set and setting items whose setting values have not been set. The setting items whose setting values have not been set are displayed as “Not Set.”

On the registration screen 850, a button name setting button 852 is an item for identifying the user setting button on the screen 620. A sending destination email address button 853 is a button for setting a sending destination email address as the setting value. A to-be-sent email content button 854 is a button for setting the contents of an email to be sent as the setting value. In response to accepting a press on the to-be-sent email content button 854, the application 401 switches the display to a to-be-sent content setting screen 860 illustrated in FIG. 8B. In response to accepting a press on a save button 856, the application 401 additionally registers the user setting having the setting values set on the registration screen (and the to-be-sent content setting screen 860). Also, the application 401 adds and displays the button name set with the button name setting button 852 to and on the screen 620.

FIG. 8B illustrates the to-be-sent content setting screen 860, which is displayed in response to accepting a press on the to-be-sent email content button 854 on the registration screen 850 in FIG. 8A. The to-be-sent content setting screen 860 includes a title region 861, in which a title is displayed and a button 869 for canceling the settings and returning to the registration screen 850 is arranged as well. A subject field 862 to input a subject, a file name input field 863, and a text field 864 to input text can accept input of any character strings by the user with the software keyboard of the information processing apparatus 101.

As described above, in the “scan and email” function, setting items set as “favorite” includes not only setting items related to scanning but also setting items such as a subject, a file name, and text. That is, the user can set any file name as a setting value in advance.

Thus, the configuration is such that the user can set any setting values for various setting items in user settings (favorite settings). Each user setting (favorite setting) is merely a set of any setting values set by the user in advance. That is, the user does not necessarily need to set the setting values of all setting items. As described with reference to FIGS. 7A and 7B, after calling a user setting (favorite setting), the user can the setting values of setting items whose setting values have not been set as appropriate. Also, after calling a user setting, the user can change the setting values of setting items whose setting values have been set as appropriate. For example, there is a case where any setting value has been set as the file name by the user in advance, as illustrated in FIG. 8B. Also, there is a case where a user setting (favorite setting) does not have a setting value set as a file name, and the user sets any file name as a setting value on the “scan and email” execution screen 730 in FIG. 7A.

In response to accepting a press on the start button 739 after settings are configured as above, the application 401 performs processing for sending a job. In the following, an example of processing in a case where setting values set in a user setting are not supported by the selected image forming apparatus will be described. Note that the “setting values set in a user setting” includes both setting values which have been registered in advance as setting values and setting values which have not been registered in advance as setting values but have been set by user operations, as described above.

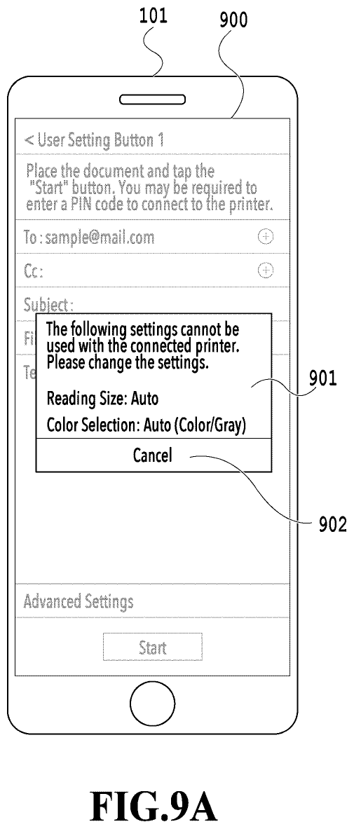

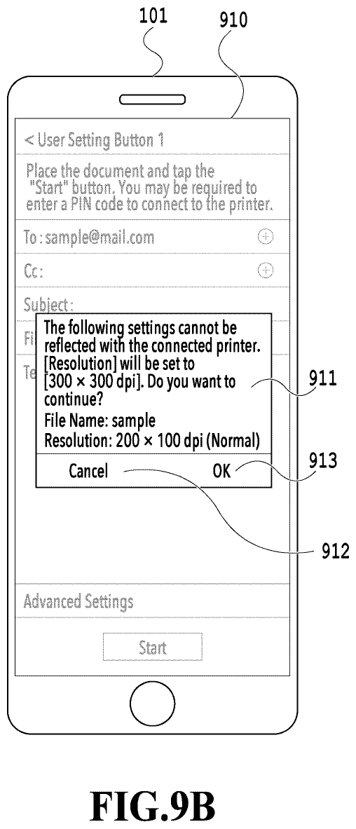

FIG. 9A is a first notification screen 900 that is displayed after accepting a press on the start button 739 in FIG. 7A in a case where the set setting values include setting values that cannot be implemented with the selected image forming apparatus. Specifically, the first notification screen 900 is displayed due to the fact that “Auto” is set as the setting value of the setting item “Reading Size,” and “Auto (Color/Gray)” is set as the setting value of the setting item “Color Selection.” These setting values are setting values that cannot be implemented with the selected image forming apparatus. For example, in a case where the selected image forming apparatus does not support the automatic selection functions, a setting with these setting values cannot be implemented. Note that whether the selected image forming apparatus supports the automatic selection functions is determined based on the ability information of the selected image forming apparatus, as described later. In a case where there are setting values that cannot be implemented with the selected image forming apparatus, then in FIG. 9A, the application 401 displays a message 901 that prompts the user to change the unimplementable setting values and a cancel button 902. In response to a press on the cancel button 902 by the user, the screen returns to the “scan and email” execution screen 730.

FIG. 9B is a second notification screen 910 that is displayed after the start button 739 is pressed in a case where setting values are set that will not (cannot) be reflected in the result of the job to be executed by the selected image forming apparatus. The second notification screen 910 displays a notification attributable to two set setting values. Specifically, the second notification screen 910 displays a notification attributable to the fact that any file name is set as the setting value of the setting item “File Name” and a setting value other than a particular setting value is set as the setting value of the setting item “Resolution.” Note that the file name “Sample” is a fixed value. That is, in FIG. 9B, “Sample” is displayed even in a case where a character string other than “Sample” is set as the setting value of the setting item “File Name.” Note that an actually set file name may be displayed as the setting value instead of a fixed value.

For example, the configuration is such that, even in a case where the first image forming apparatus receives a job in which any file name is set as the setting value of the setting item “File Name,” a file name will be given in accordance with rules specified for the first image forming apparatus. Also, the configuration is such that, even in a case where the first image forming apparatus receives a job in which any resolution is set as the setting value of the setting item “Resolution,” the scan will be performed at a resolution specified for the first image forming apparatus. That is, the first image forming apparatus can receive and execute a job in which setting values are set for the setting items “File Name” and “Resolution.” However, the first image forming apparatus does not use the setting values set for the setting items “File Name” and “Resolution” to execute the job. Thus, the setting values set for the setting items “File Name” and “Resolution” are not reflected in the result of the job executed by the first image forming apparatus.

On the other hand, in a case where the second image forming apparatus, which is different from the first image forming apparatus, receives a job in which setting values are set for the setting items “File Name” and “Resolution,” the second image forming apparatus uses those setting values to perform processing to execute the job. That is, the setting values set for the setting items “File Name” and “Resolution” are reflected in the result of the job executed by the second image forming apparatus.

Such a difference between the first and second image forming apparatuses originates from the difference between their platforms.

Here, as described above, in a case where the first image forming apparatus receives a job in which setting values are set for the setting items “File Name” and “Resolution,” the first image forming apparatus can still execute the job. Thus, in a case where setting values that will not be reflected in the result of the job to be executed are set, the second notification screen 910 in FIG. 9B, which includes a button for accepting execution of the job unlike the first notification screen 900 illustrated in FIG. 9A, is displayed. The second notification screen 910 displays a message 911 indicating that particular setting values cannot be reflected in the job result and confirming whether to execute the job, a cancel button 912, and an OK button 913. In response to a press on the cancel button 912 by the user, the screen returns to the “scan and email” execution screen 730. On the other hand, in response to a press on the OK button 913 by the user, the application 401 performs a job sending process. That is, in a case where the user thinks that the job may be executed even though the particular setting values cannot be reflected in the job result, and inputs an instruction to execute the job, the application 401 performs a process of sending the job.

While FIGS. 6A to 9B illustrate an example of the home screen and screens for the “scan and email” function, the screens are not limited to the illustrated screen example. Also, the various setting screens are not limited to the illustrated example.

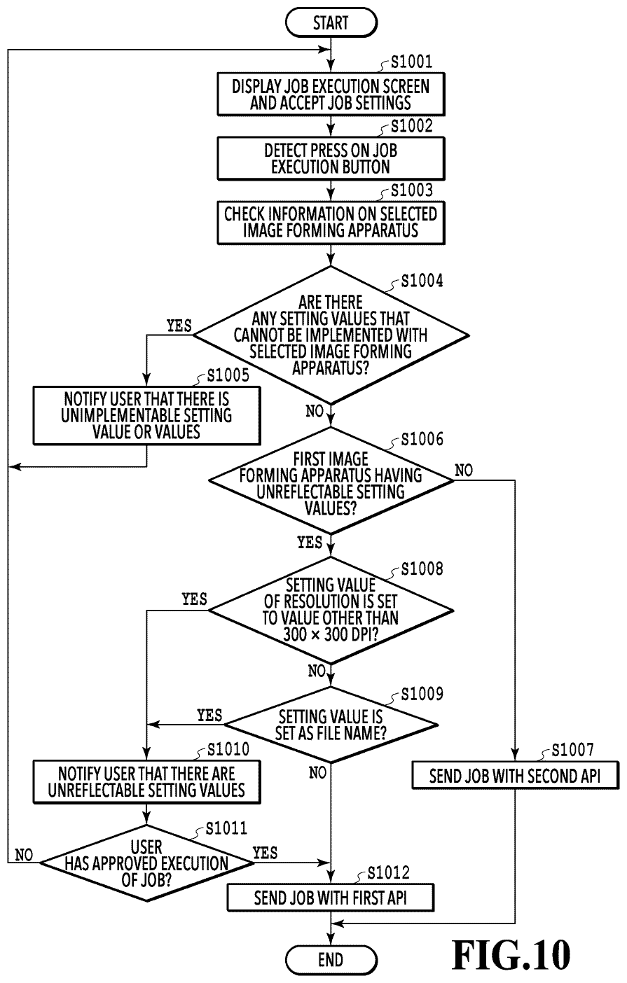

FIG. 10 is a flowchart illustrating an example of processing for checking job settings in a case where the information processing apparatus 101 sends job information to the image forming apparatus 104. The CPU 202 of the information processing apparatus 101 implements the processing illustrated in FIG. 10 by functioning as the functional components of the application 401 illustrated in FIG. 4, as mentioned earlier. That is, the CPU 202 implements the flowchart of FIG. 10 by reading out a program stored in the ROM 203, the storage device 209, or the like into the RAM 204 and executing it. Incidentally, the functions of some or all of the steps in FIG. 10 may be implemented with hardware, such as an application-specific integrated circuit (ASIC) or an electronic circuit. The symbol “S” in the description of each process means a step in the flowchart (the same applies to the other flowcharts herein). The processing illustrated in FIG. 10 is initiated in response to a press on a predetermined function button on the home screen 600 illustrated in FIG. 6A, for example.

At the point of starting the flowchart of FIG. 10, the application 401 has already specified the image forming apparatus 104 to which to send job information. That is, the application 401 has already selected a sending destination image forming apparatus and specified the selected image forming apparatus. The present embodiment will describe, as an example, a case where the “Scan and Email” function 605 on the home screen 600 on the information processing apparatus 101 is selected by the user and sends job information for “scan and email.” Note that the function is not limited to “scan and email,” and the flowchart of FIG. 10 is applicable also to a case of sending job information of another job, such as a fax job or a print job. Also, this flowchart assumes a case where the user sends the job information to the selected image forming apparatus 104 from the information processing apparatus 101 in a state where the user is not logged in to the image forming apparatus.

In S1001, the UI control component 402 displays a job execution screen and accepts job settings. For example, the UI control component 402 displays the “scan and email” execution screen 730 in FIG. 7A or the advanced setting screen 740 in FIG. 7B, and accepts job settings from the user. Then, in S1002, the UI control component 402 accepts a press on a job execution button (e.g., start button 739). The UI control component 402 accepts various settings in S1001 until detecting a press on the start button 739 by the user.

Then, in S1003, the job control component 407 checks information on the selected image forming apparatus 104. For example, the job control component 407 checks information on the image forming apparatus 104 obtained by connecting to the image forming apparatus through the device connection component 404 at the time of registering the image forming apparatus. In this example, the information on the image forming apparatus 104 is a platform name of a firmware controller of the image forming apparatus 104. Also, the information on the image forming apparatus 104 is obtained when the information processing apparatus 101 and the image forming apparatus 104 are connected through the device connection component 404 (e.g., when the above-mentioned registration is performed).

Then, in S1004, the job control component 407 determines whether there are any setting values that cannot be implemented with the selected image forming apparatus based on the ability information of the image forming apparatus 104 in the information on the image forming apparatus checked in S1003. For example, the job control component 407 determines whether color scanning is set for an image forming apparatus supporting only monochrome scanning, and whether a document size other than the readable document sizes supported by the image forming apparatus is set or a magnification with which to change the document size to that size is set. Additionally, the job control component 407 determines whether double-side reading or output is set for a device model not supporting double-side reading or output, whether stapling is set despite the fact that the image forming apparatus has no finisher, and so on. If there are any setting values that cannot be implemented with the selected image forming apparatus, the job control component 407 proceeds to S1005 and, if not, proceeds to S1006.

In S1005, the UI control component 402 notifies the user that there is an unimplementable setting value or values. Specifically, as illustrated in FIG. 9A, the UI control component 402 displays the first notification screen 900 notifying of the message 901 prompting the user to change setting values. The first notification screen 900 includes the cancel button 902. If the user presses the cancel button 902, the job control component 407 returns to S1001. Specifically, if the cancel button 902 on the first notification screen 900 is pressed, the UI control component 402 transitions to the job execution screen.

In S1006, based on the information on the image forming apparatus 104 checked in S1003, the job control component 407 determines whether the selected image forming apparatus is the first image forming apparatus with unreflectable setting values. Incidentally, an image forming apparatus with no unreflectable setting value is the second image forming apparatus. An “unreflectable setting value” means a setting value that cannot be reflected in an executed job. That is, even in a case where that setting value is set, the job itself can still be executed. Specifically, in S1006, the job control component 407 determines the type of the image forming apparatus 104 checked in S1003 and determines whether the selected image forming apparatus is the first image forming apparatus or the second image forming apparatus. The job control component 407 proceeds to S1008 if the selected image forming apparatus is an image forming apparatus with unreflectable setting values, i.e., the first image forming apparatus and, if not, that is, the selected image forming apparatus is the second image forming apparatus, proceeds to S1007. In this example, whether the selected image forming apparatus is an image forming apparatus with setting values that cannot be reflected in the job result is determined based on the platform name of the firmware controller checked in S1003.

The functions and cost of an image forming apparatus vary depending on where it is used or its purpose of use. The platform of the firmware controller included in an image forming apparatus also varies depending on the constraints on the functions and cost. For example, a large image forming apparatus capable of handling sheet sizes up to A3 and a small image forming apparatus capable of handling only sheet sizes up to A4 and not capable of handing the A3 sheet size tend to have different platforms for their firmware controllers. The platform of the firmware controller included in the image forming apparatus capable of handling only sheet sizes up to A4 is limited in terms of performance as compared to the image forming apparatus capable of handling sheet sizes up to A3. Specifically, from the perspective of cost, there are limitations on the available functions and on the performance of hardware such as the RAM or the ROM. This results also in differences in the performance of the held application programming interface (API). One of these differences is the difference between having unreflectable setting values and having no unreflectable setting value. That is, in the present embodiment, there is an image forming apparatus 104 whose device model holds a first API having unreflectable setting values (i.e., the first image forming apparatus). Further, in the present embodiment, there is an image forming apparatus 104 whose device model holds a second API having no unreflectable setting value (that is, all of corresponding setting values can be reflected) (i.e., the second image forming apparatus). Moreover, the firmware controllers of these device models have different platform names. Thus, the job control component 407 can determine whether the selected image forming apparatus is the image forming apparatus having unreflectable setting values by referring to the platform name of the firmware controller. As mentioned earlier, an image forming apparatus with a first platform having unreflectable setting values is referred to as the first image forming apparatus. An image forming apparatus with a second platform having no unreflectable setting value is referred to as the second image forming apparatus.

Specifically, the large image forming apparatus capable of handling sheet sizes up to A3 is a device model having no unreflectable setting value. The small image forming apparatus capable of handling only sheet sizes up to A4 and not capable of handing the A3 sheet size is the device model having unreflectable setting values.

In the determination in S1006, the job control component 407 determines “YES” if the information on the image forming apparatus 104 checked in S1003 includes the platform name of the firmware controller included in the device model having unreflectable setting values. The job control component 407 determines “NO” if the information on the image forming apparatus 104 checked in S1003 includes the platform name of the firmware controller included in the device model having no unreflectable setting value.

Note that the application 401 is provided in advance with information for specifying which platform name is the first platform or the second platform in the form of a table, for example. Thus, the determination in S1006 is executed based on information obtained from the image forming apparatus 104 and information provided in advance to the application 401 and not obtained from the image forming apparatus 104. Note that the platform name is an example, and the determination in S1006 does not need to be based on the platform name. Only information related to the device model with which the type of the apparatus can be specified (hereinafter referred to also as “device model information”) is sufficient. That is, as the device model information, the platform name of the firmware controller may be referred to or information other than the platform name may be referred to. Specifically, as the device model information, the device model name of the image forming apparatus 104 may be referred to. In this configuration, there are a device model corresponding to the first platform and a device model corresponding to the second platform, for example. In S1006, it is determined whether the device model name of the image forming apparatus 104 is the device model name corresponding to the first platform or the device model name corresponding to the second platform. That is, the job control component 407 determines YES if the information on the image forming apparatus 104 checked in S1003 includes the device model name of a device model having unreflectable setting values. The job control component 407 determines NO if the information on the image forming apparatus 104 checked in S1003 includes the device model name of a device model having no unreflectable setting value. Note that there are multiple device model names that use the first platform, for example. That is, processing using a smaller range of device model names than the platform names may be employed. Also, besides the device model name, the serial number of the image forming apparatus 104 or the capability information of the image forming apparatus 104, for example, may be used in the determination in S1006.

Referring back to FIG. 10, a case where the image forming apparatus 104 has the second platform having no unreflectable setting value will now be described. In S1007, the job control component 407 sends the job to the image forming apparatus 104 using the second API held in the image forming apparatus 104. Then, the job control component 407 terminates the processing in the flowchart illustrated in FIG. 10.

Next, a case where the image forming apparatus 104 has the first platform having unreflectable setting values will be described. In S1008, the job control component 407 determines whether the setting value of the setting item “Resolution” is set to 300×300 dpi. This is because an image forming apparatus having the first platform is only capable of executing jobs with a resolution of 300×300 dpi, unlike an image forming apparatus having the second platform. Also, an image forming apparatus having the first platform executes jobs with a resolution of 300×300 dpi regardless of whether a setting value is set for the setting item “Resolution” or not. For this reason, in a case where 300×300 dpi is set as a setting value, a job based directly on this setting value will not be executed, but a job result with the same setting value of the setting item “Resolution” as this setting value will be obtained. The determination in S1008 is made with this point taken into account. The job control component 407 proceeds to S1010 if the setting value of the resolution is set to a value other than 300×300 dpi and, if not, proceeds to S1009.

In S1009, the job control component 407 determines whether a setting value is set for the setting item “File Name.” Specifically, the job control component 407 determines that no file name is set as a setting value if the file name is an empty string, and determines that a file name is set if the file name is not an empty string. File names cannot be set with the first API held in an image forming apparatus having the first platform. For this reason, the setting value of the setting item “File Name” is checked in S1009. Note that, with an image forming apparatus having the first platform, a file name is given in accordance with rules specified in advance for the image forming apparatus. Specifically, a file name is determined using a character string such as the date on which the image forming apparatus actually executes the job. If a file name is set, the job control component 407 proceeds to S1010 and, if not, proceeds to S1012. The case of proceeding from S1009 to S1012 is a case where the selected image forming apparatus is an image forming apparatus having the first platform but no unreflectable setting value is set.

In S1010, the UI control component 402 displays the second notification screen 910 (FIG. 9B) for notifying that there are unreflectable setting values. Unlike the first notification screen 900, the second notification screen 910 displays both the OK button 913 for accepting the execution of the job, and the cancel button 912 for canceling the execution of the job, as described earlier. That is, the second notification screen 910 is a screen capable of accepting a user operation for executing the job.

S1010 is followed by S1011, in which the job control component 407 determines whether the user has approved the execution of the job. Specifically, if accepting an operation of pressing the OK button 913 in FIG. 9B by the user, the job control component 407 determines that the user has approved the execution of the job. On the other hand, if accepting an operation of pressing the cancel button 912 in FIG. 9B by the user, the job control component 407 determines that the user has not approved the execution of the job. The job control component 407 proceeds to S1012 if determining that the user has approved the execution of the job, and returns to S1001 if determining that the user has not approved the execution of the job.

In S1012, the job control component 407 sends the job to the image forming apparatus 104 using the first API held in the image forming apparatus 104. At this time, the job control component 407 uses the first API to send to the job. Hence, the job control component 407 converts the job information in accordance with the format of the first API but does not include the setting values of the resolution and the file name in the converted job information. Specifically, the job control component 407 does not add a resolution and a file name as parameters in a job sending command of the first API. That is, the job control component 407 does not send setting information in a format including setting values as a resolution and a file name to the first image forming apparatus. Note that, in a case where the user approves the execution of the job after the second notification screen 910 is displayed in S1011 and the processing proceeds to S1012, the job control component 407 does not add the resolution and the file name as parameters. Also, the job control component 407 does not add the resolution and the file name as parameters also in a case where the processing proceeds to S1012 from S1009 without issuing a notification.

Note that the present embodiment assumes a case where the user sets in advance a particular setting value of a particular setting item or items in a user setting (favorite setting), but is not necessarily limited to this example. For example, assume a case where a first user setting (favorite setting) is saved with no setting value set for the setting item “Resolution.” In this case, the user may then call the first user setting, thereafter press the advanced setting button 738 in FIG. 7A, press the resolution setting button 743 on the advanced setting screen 740 in FIG. 7B, sets the setting value of the resolution to 200×200 dpi, for example, and further press the start button 739 in FIG. 7A. In this case too, as described in the flowchart illustrated in FIG. 10, processing is performed based on the settings at the point when the start button 739 was pressed. Accordingly, in this example, it is determined YES in S1008.

As described above, the processing in the flowchart illustrated in FIG. 10 involves two cases of notifying (warning) the user. A first case is a case where it is determined that there is a setting value or values that cannot be implemented with the selected image forming apparatus (S1005). A second case is a case where it is determined that there is a setting value or values that are not unimplementable with the selected image forming apparatus but will not be reflected in the job result (S1010). The setting items used in the determination in the first case and the setting items used in the determination in the second case are different. That is, the determination criteria in the first case and the determination criteria in the second case are different. The first notification screen displayed as a result of the first case and the second notification screen displayed as a result of the second case are screens with different contents. Specifically, the first notification screen is a screen incapable of accepting input of an instruction to send a job. On the other hand, the second notification screen is a screen capable of accepting input of an instruction to send a job.

As described above, the present embodiment can improve usability in a case where the information processing apparatus 101 causes a communication apparatus (image forming apparatus 104) to execute a job. Specifically, in the present embodiment, in a case of sending a job to any image forming apparatus using a job setting saved in the information processing apparatus 101, a predetermined notification screen (second notification screen) is displayed if an unreflectable setting value or values are set. The predetermined notification screen is configured to be capable of displaying a predetermined notification message, accepting an instruction to execute the job, and accepting an instruction to cancel the execution of the job. In this way, the job can be executed based on the user's decision. Specifically, in a case where the selected image forming apparatus is the first image forming apparatus having unreflectable setting values, the application 401 of the information processing apparatus 101 checks the setting values of the setting items “Resolution” and “File Name.” Then, the application 401 notifies with a notification screen that those setting values must be particular setting values to be reflected. The user inputs an instruction to execute the job in a case where it is acceptable for the user to execute the job without the setting values designated by the user. This eliminates the need to cancel the execution of the job without exception and thus improves usability.

### Second Embodiment

The first embodiment has described an example in which the second notification screen 910 as illustrated in FIG. 9B is displayed in S1001 in a case where the resolution is other than 300×300 dpi in S1008 and also a file name is set in S1009. The second notification screen 910 in FIG. 9B is a screen example in which neither the setting item “File Name” nor “Resolution” will not be reflected in the setting values. The configuration that displays a common screen (single screen) to notify that the setting values cannot be reflected makes it for the application 401 to be implemented. In this way, however, the user is unable to figure out which setting value or values cannot be reflected.

With this taken into consideration, a second embodiment will describe an example in which the user is notified of which setting value or values cannot be reflected based on the setting values set for the setting items “Resolution” and “File Name.” The basic configuration in the second embodiment is the same as the example described in the first embodiment, and therefore the difference will be mainly described.

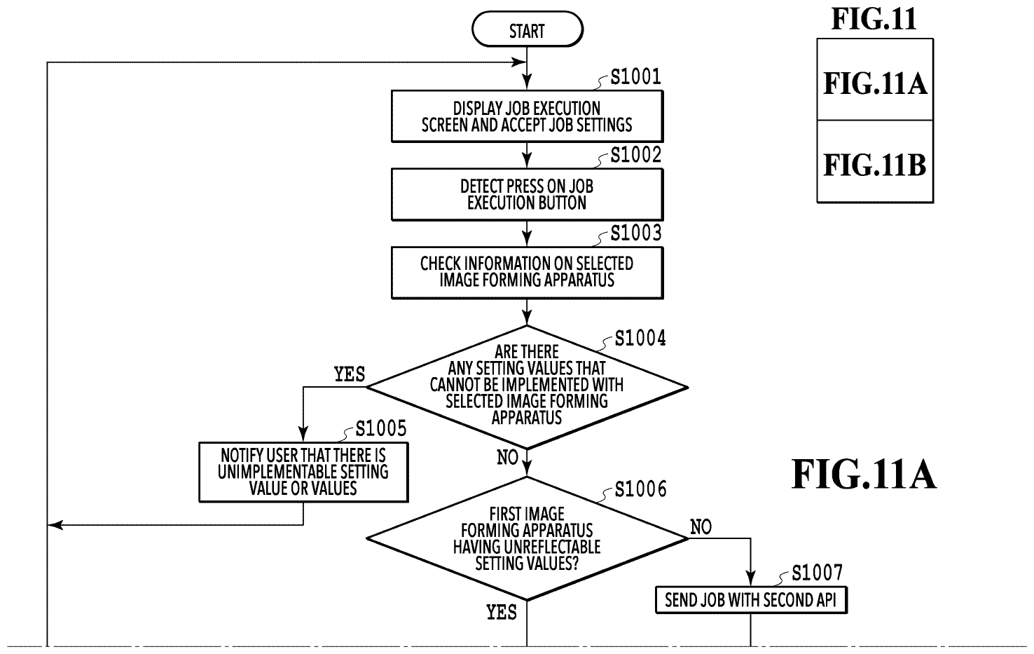

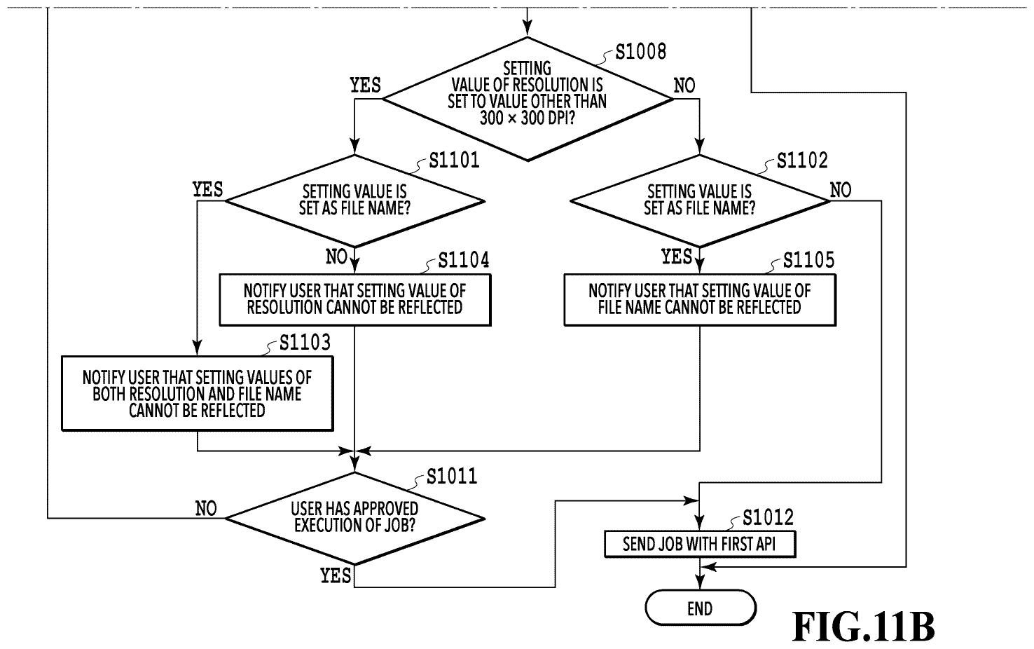

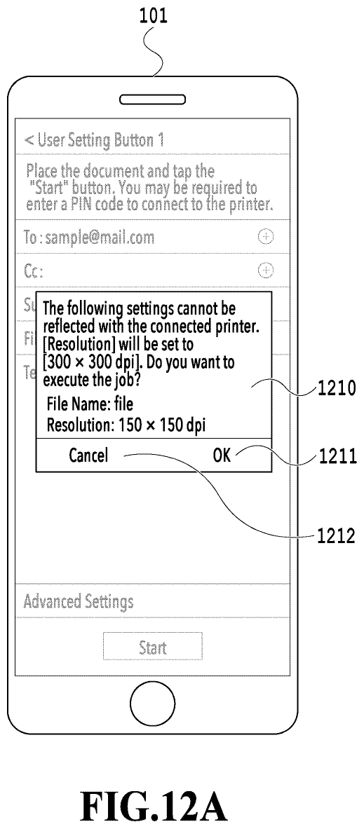

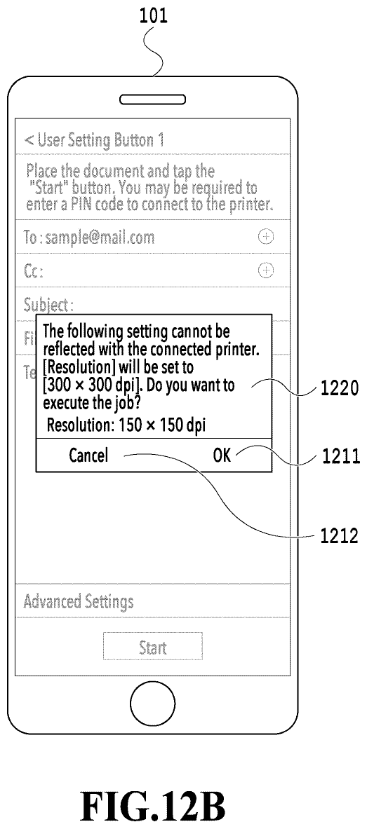

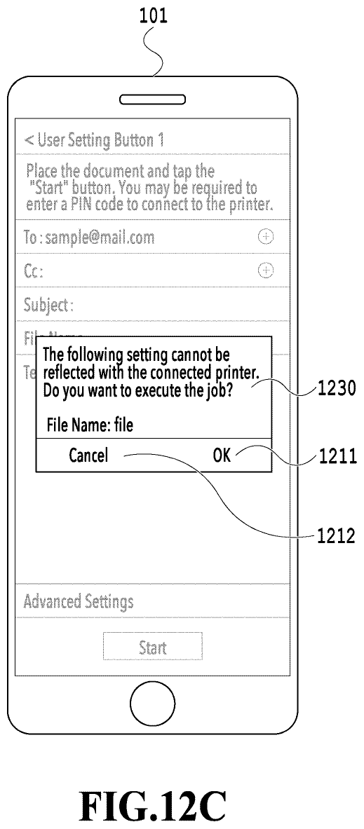

FIGS. 11A and 12 are totally a flowchart illustrating an example of control processing for setting values performed in a case where the information processing apparatus 101 sends job information to the image forming apparatus 104. As in the example described in the first embodiment, the CPU 202 of the information processing apparatus 101 also implements the processing illustrated in FIGS. 11A and 11B by functioning as the functional components illustrated in FIG. 4, as mentioned earlier. Also, the trigger to initiate the processing in FIGS. 11A and 11B is also similar to that in the example described in the first embodiment.

The same processes in FIGS. 11A and 11B as those illustrated in FIG. 10 are denoted by the same reference signs as those in FIG. 10, and description thereof is omitted. In the present embodiment, if the setting value of the resolution is set to a value other than 300×300 dpi in S1008, the job control component 407 proceeds to S1101 and, if not, proceeds to S1102.

In S1101, the job control component 407 determines whether a setting value is set as a file name. If a setting value is set as a file name, the job control component 407 proceeds to S1103 and, if not, proceeds to S1104.

In S1102 too, the job control component 407 likewise determines whether a setting value is set as a file name. If a setting value is set as a file name, the job control component 407 proceeds to S1105 and, if not, proceeds to S1012.

FIGS. 12A to 12C are diagrams illustrating examples of a notification screen notified of in the present embodiment. In each of FIGS. 12A to 12C, an OK button 1211 capable of accepting a user operation as an instruction to execute a job and a cancel button 1212 capable of accepting a user operation as an instruction to cancel the execution of the job are displayed.

In S1103, the UI control component 402 notifies the user that the setting values of both the file name and the resolution cannot be reflected. Specifically, the UI control component 402 displays a second notification screen 1210 illustrated in FIG. 12A. Here, “file” displayed as a file name on the second notification screen 1210 is a value displayed as an actual setting value. Thereafter, the job control component 407 proceeds to S1011.

In S1104, the UI control component 402 notifies the user that the setting value of the resolution cannot be reflected. Specifically, the UI control component 402 displays a second notification screen 1220 illustrated in FIG. 12B. Thereafter, the job control component 407 proceeds to S1011.

In S1105, the UI control component 402 notifies the user that the setting value of the file name cannot be reflected. Specifically, the UI control component 402 displays a second notification screen 1230 illustrated in FIG. 12C. Here, “file” displayed as a file name on the second notification screen 1230 is a value displayed as an actual setting value. Thereafter, the job control component 407 proceeds to S1011.

As described above, in the present embodiment, an example in which a different second notification screen is displayed in each of a case where the setting values of both the file name and the resolution cannot be reflected, a case where only the setting value of the resolution cannot be reflected, and a case where only the setting value of the file name cannot be reflected. In this way, the user can figure out which setting value or values cannot be reflected. Also, as described in the first embodiment, the second notification screen is configured to be capable of displaying a predetermined notification message, accepting an instruction to execute the job, and accepting an instruction to cancel the execution of the job. This improves usability.

### OTHER EMBODIMENTS

In each of the above embodiments, a description has been given of control performed in a case where there are setting values that cannot be reflected in the result of a job that uses a user setting (favorite setting) registered in advance in the application 401 when the job is sent to any image forming apparatus. Moreover, control for the “Scan and Email” function 605 as a specific function has been described. Further, a function for which such a user setting (favorite setting) can be configured has been described as “particular function.” Specifically, an example in which there are three “particular functions,” namely the “scan and email” function, the “fax” function, and “copy” function, has been described. Of these three particular functions, the “scan and email” function is a function which may have setting values that cannot be reflected in a job result depending on the image processing apparatus. There are no setting values that cannot be reflected for the other functions, namely, the “fax” function (fax job) and the “copy” function (copy job). Hence, the determinations in S1008 and S1009 in FIG. 10, for example, are determinations to be made in a case where the function whose job execution button is detected to be pressed in S1002 is the first function among the particular functions (specifically, “scan and email” function). In a case where the function whose job execution button is detected to be pressed in S1002 is a second function other than the first function among the particular functions, determining YES in S1006 will be followed by the process of S1012. That is, in the case where the function whose job execution button is detected to be pressed in S1002 is the second function other than the first function among the particular functions, the notification with the second notification screen in S1010 will not be made. While the above description is given based on the first embodiment, the second embodiment does likewise involve making the notification with the second notification screen in the case where the function is the second function other than the first function among the particular functions. Thus, the processing may be such that, for example, a process of determining whether the function is the first function among the particular functions” (S1) is added after YES in S1006, and the processing proceeds to S1008 if YES in S1 and proceeds to S1012 if NO in S1.

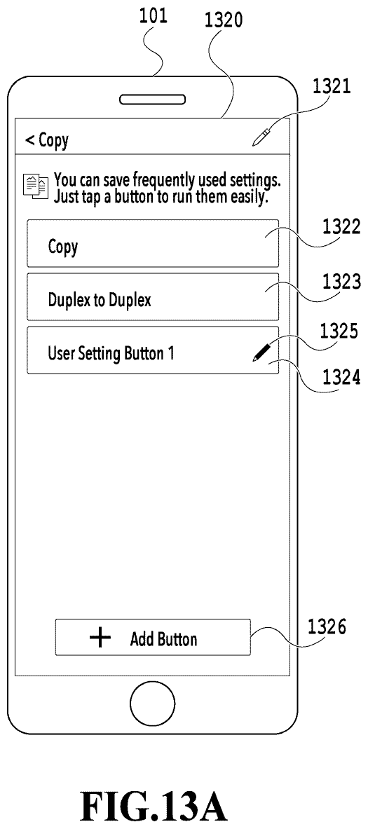

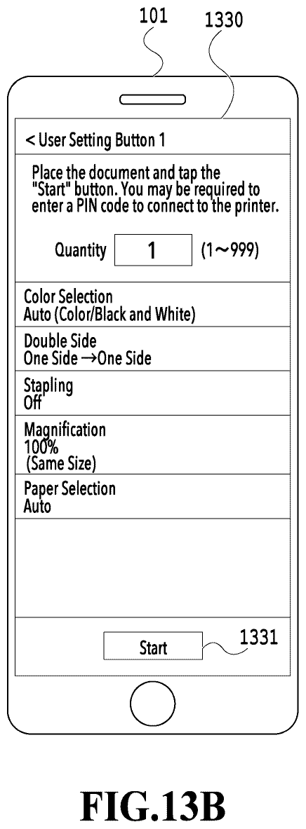

FIGS. 13A and 13B are diagrams illustrating an example of screens for a user setting (favorite) of the “copy” function among the particular functions.

In response to accepting a press on the “copy” function 607 in FIG. 6A by the user, the application 401 transitions to a screen on which registered job settings are listed (FIG. 13A). A screen 1320 in FIG. 13A displays three registered job settings in the form of buttons, but this is an example. The display method, including the number of registered job settings to be displayed and the display names, may be different from that in the example of FIG. 13A. A “Copy” button 1322 and a “Duplex to Duplex” button 1323 represent job settings registered as presets. A “User Setting Button 1” 1324 is a job setting including job setting values customized and registered in the application 401 by the user. The user can press a setting edit button 1325 displayed on a right portion of the “User Setting Button 1” 1324 to change the setting values of a registered job setting. The user can press an add button 1326 to newly register a job setting with customized setting values (“favorite” setting) in the application 401. The application 401 is capable of, for example, changing the order of the listed job settings and deleting registered job settings from the application 401 in a case of accepting a press on an edit button 1321.

FIG. 13B is a screen that is displayed in response to a press on the “User Setting Button 1” 1324 by the user. FIG. 13B represents a state where color selection, double-side printing, stapling, magnification, and sheet selection are included as setting items, and a setting value is set for each setting item. A start button 1331 is a button for sending job information to the image forming apparatus 104.

As described above, for the “copy” function, which is a particular function, various setting values can be set regardless of the ability information of the selected image forming apparatus. Here, while the “copy” function is a particular function, it is not the first function and is a second function. That is, the setting items in FIG. 13B have no unreflectable setting values for the selected image forming apparatus. However, the setting items in FIG. 13B may have umimplementable setting values for the selected image forming apparatus. That is, in a case where the start button 1331 for the “copy” function is pressed, the notification screen in S1005 (first notification screen) may be displayed but the notification screen in S1010 (second notification screen) will not be displayed.

Also, the “Scan” function 604, which is a function for scanning, is included as a function other than the particular functions. As described earlier, for the functions other than particular functions, the application 401 is configured to obtain the ability information of the selected image forming apparatus and allow the user to select settable setting values based on the obtained ability information. Like the “Scan” function 604, for the functions other than the particular functions, control to be performed in a case where there are unreflectable setting values as described in the above embodiments is not performed.

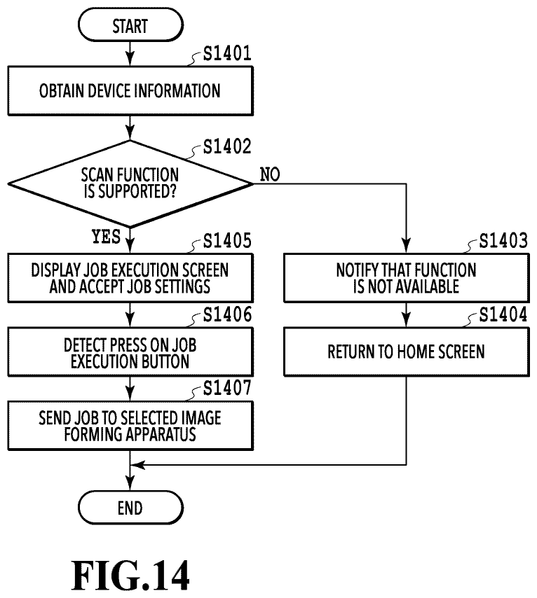

FIG. 14 is a diagram illustrating for reference an example of a flowchart in a case where the “Scan” function 604 is pressed in a state where the above-mentioned first image forming apparatus or second image forming apparatus is the selected image forming apparatus. The CPU 202 of the information processing apparatus 101 also implements the processing illustrated in FIG. 14 by functioning as the functional components of the application 401 illustrated in FIG. 4, as mentioned earlier. The processing illustrated in FIG. 14 is an example initiated in response to a press on the button of the “Scan” function 604 on the home screen 600 illustrated in FIG. 6A.

In S1401, the job control component 407 obtains device information from the selected image forming apparatus. The device information includes the ability information of the image forming apparatus. In S1402, the job control component 407 determines whether the selected image forming apparatus supports a scan function. This determination is made based on the device information obtained in S1401. If determining that the selected image forming apparatus supports a scan function, the job control component 407 proceeds to S1405. If determining that the selected image forming apparatus does not support a scan function, the job control component 407 proceeds to S1403. In S1403, the UI control component 402 notifies that the function is not available (not illustrated). Then, in S1404, the job control component 407 returns to the home screen and terminates the processing in the flowchart illustrated in FIG. 14.

In S1405, the UI control component 402 displays a job execution screen and accepts job settings.

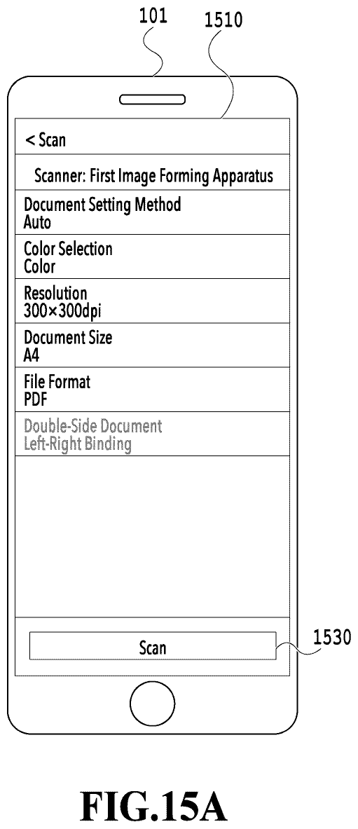

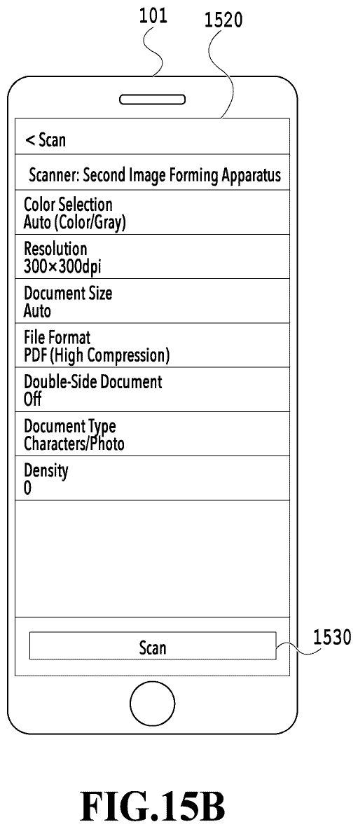

FIGS. 15A and 15B are diagrams illustrating examples of the job execution screen displayed in S1405. FIG. 15A is an example of a job execution screen 1510 in the case where the selected image forming apparatus is the above-mentioned first image forming apparatus. FIG. 15B is an example of a job execution screen 1520 in the case where the selected image forming apparatus is the above-mentioned second image forming apparatus. These job execution screens 1510 and 1520 are in a state where setting items and setting values are set based on the device information obtained in S1401. Default setting values are set on the job execution screens 1510 and 1520. The default setting values are set based on the device information as well. On these job execution screens 1510 and 1520, the user can change setting values based on user operations. However, setting values which the application 401 can accept on the job execution screens 1510 and 1520 are only setting values which can be implemented with the image forming apparatus selected on the application 401. When obtaining the device information of the image forming apparatus in S1401, the application 401 also obtains the setting values which can be implemented with the image forming apparatus. For this reason, the application 401 is configured to be capable of accepting setting of setting values which can be implemented with the selected image forming apparatus.

In S1406, the job control component 407 detects a pressed on a job execution button. Specifically, the job control component 407 detects a press on a scan button 1530 on the job execution screen 1510 or 1520. In S1407, the job control component 407 sends a job to the selected image forming apparatus. Then, the job control component 407 terminates the processing in the flowchart illustrated in FIG. 14. Thereafter, the image forming apparatus executes a scan process, and the read image data is sent to the application 401 and displayed on the application 401.

As described above, for the “Scan” function 604, setting values based on the ability information of the selected image forming apparatus are set. Accordingly, the above-described second notification screen 910, of course, will not be displayed nor will the first notification screen 900.

Note that, as illustrated in FIGS. 15A and 15B, default setting values are set on the job execution screens 1510 and 1520 based on the device information (ability information) obtained from the selected image forming apparatus. Moreover, in a case of changing the setting values on the job execution screens 1510 and 1520, candidate setting values are dependent on the ability information of the selected image forming apparatus. That is, only setting values supported by the selected image forming apparatus are candidate setting values for the job execution screens 1510 and 1520.

On the other hand, setting values that can be set in user settings (favorite settings) as described in the above embodiments are different from those on the job execution screens 1510 and 1520 in the following aspects. First, user settings (favorite settings) can be registered using any setting values input or selected by the user. Also, the user can register multiple user settings (favorite settings), such as User Setting 1 and User Setting 2. Then, the user can select any setting which they wish to call from among the multiple settings. Furthermore, any candidate setting values input or selected by the user for user settings (favorite settings) are not dependent on the ability information of the selected image forming apparatus. For this reason, setting values not supported by the selected image forming apparatus can be candidate setting values.

Note that the home screen 600 is a screen that varies depending on the type of the selected image forming apparatus. An example in a case where the third image forming apparatus, which is an inkjet image forming apparatus, is selected on the application 401 will now be described. In the case where the selected image forming apparatus is the third image forming apparatus, the “Scan and Email” function 605 is hidden on the home screen 600. On the other hand, the “Scan” function 604 is displayed. That is, in the case where the selected image forming apparatus is the third image forming apparatus, the above-described particular functions, for which user settings (favorite settings) can be set, are not displayed. For this reason, in the case where the selected image forming apparatus is the third image forming apparatus, any of the above-described setting screens for setting a user setting (favorite setting) is not displayed either.

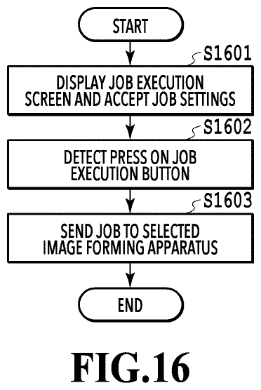

FIG. 16 is a diagram illustrating an example of a flowchart in a case where the “Scan” function 604 is pressed in a state where the selected image forming apparatus is the third image forming apparatus.

In S1601, the UI control component 402 displays a job execution screen and accepts job settings. With the third image forming apparatus, information on the image forming apparatus including its ability to implement a “scan” function is obtained when the image forming apparatus is registered in the application 401, as described earlier. Thus, as for the job settings to be accepted in S1601 too, only setting values that can be implemented with the image forming apparatus selected on the application 401 can be accepted. The subsequent processes of S1602 and S1603 are similar to the processes of S1406 and S1407. As described above, in a case where the “Scan” function 604 of the third image forming apparatus is selected, too, neither the second notification screen 910 nor the first notification screen 900 as described in the above embodiments is displayed. That is, control for unreflectable setting values as described in the above embodiments is not performed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to improve usability in a case where an information processing apparatus causes a communication apparatus to execute a job.

This application claims the benefit of Japanese Patent Application No. 2024-126029, filed Aug. 1, 2024, which is hereby incorporated by reference herein in its entirety.

What is claimed is:

1. A method of controlling an information processing apparatus, the method comprising:
performing a first specification operation of specifying a plurality of setting values set for a plurality of setting items related to a scan job for causing a communication apparatus to execute a scan;
performing a second specification operation of specifying the setting value set for a particular setting item among the plurality of setting values;
performing a third specification operation of specifying information on a device model of a communication apparatus selected as a destination to send the scan job;
performing a first control operation of performing control to display a predetermined notification screen based on a fact that the setting value set for the particular setting item is specified to be a first value and the information on the device model of the communication apparatus is specified to be information corresponding to a first device model, and performing control not to display the predetermined notification screen in a case where the setting value set for the particular setting item is specified to be the first value but the information on the device model of the communication apparatus is specified to be information corresponding to a second device model different from the first device model; and
performing a second control operation of performing control to send the scan job not including information on the particular setting item to the communication apparatus selected as the sending destination based on a fact that a first operation is performed on the predetermined notification screen, and performing control not to send the scan job to the communication apparatus selected as the sending destination based on a fact that a second operation different from the first operation is performed on the predetermined notification screen.

2. The method of controlling an information processing apparatus according to claim 1, wherein
the first specification operation, the second specification operation, the third specification operation, the first control operation, and the second control operation are executed in a case where an instruction to execute the scan job is accepted on a first screen which accepts execution of the scan job,
the first control operation displays the predetermined notification screen in place of the first screen, and
the second control operation displays the first screen in place of the predetermined notification screen based on a fact that the second operation is performed on the predetermined notification screen.

3. The method of controlling an information processing apparatus according to claim 1, wherein the plurality of setting values specified in the first specification operation are set without being based on an ability of the communication apparatus selected as the sending destination.

4. The method of controlling an information processing apparatus according to claim 1, wherein
a first setting and a second setting each of which is a set of a plurality of setting items related to the scan job are registered, and at least some of the plurality of setting values set in the first setting are different from the plurality of setting values set in the second setting, and
the first specification operation specifies the plurality of setting values set in the first setting based on a fact that the first setting is selected, and specifies the plurality of setting values set in the second setting based on a fact that the second setting is selected.

5. The method of controlling an information processing apparatus according to claim 1, wherein
the particular setting item includes a first setting item and a second setting item different from the first setting item,
the first value is different for the first setting item and the second setting item, and
the predetermined notification screen varies depending on whether the setting item set to the first value is the first setting item, the second setting item, or both the first setting item and the second setting item.

6. The method of controlling an information processing apparatus according to claim 1, wherein
the particular setting item includes a first setting item and a second setting item different from the first setting item,
the first value is different for the first setting item and the second setting item, and
the predetermined notification screen is a same screen regardless of whether the setting item set to the first value is the first setting item, the second setting item, or both the first setting item and the second setting item.

7. The method of controlling an information processing apparatus according to claim 1, wherein the particular setting item includes a file name, and the first value corresponding to the file name is a value that is not an empty string.

8. The method of controlling an information processing apparatus according to claim 1, wherein the particular setting item includes a resolution, and the first value corresponding to the resolution is a particular resolution value.

9. The method of controlling an information processing apparatus according to claim 1, wherein the scan job is a job of attaching a result of a scan executed by the communication apparatus to a file and sending the file to a predetermined destination.

10. The method of controlling an information processing apparatus according to claim 1, further comprising
performing a fourth specification operation of specifying an ability of the communication apparatus selected as a destination to send the scan job, wherein
the first control operation performs control to display a first notification screen which is a notification screen different from the predetermined notification screen in a case where any of the plurality of setting values specified in the first specification operation is a setting value that does not correspond to the ability of the communication apparatus specified in the fourth specification operation.

11. The method of controlling an information processing apparatus according to claim 10, wherein the second control operation performs control not to accept the first operation on the first notification screen and performs control to allow the second operation to be accepted on the first notification screen.

12. The method of controlling an information processing apparatus according to claim 1, further comprising:
performing a fourth specification operation of specifying an ability of the communication apparatus selected as a destination to send the scan job; and
performing a fifth specification operation of specifying setting values corresponding to respective setting items from among only setting values corresponding to the ability of the communication apparatus specified in the fourth specification operation, wherein
the first control operation performs control not to display the predetermined notification screen based on a fact that the setting values are specified in the fifth specification operation instead of the first specification operation.

13. The method of controlling an information processing apparatus according to claim 12, wherein
the scan job includes a first scan job and a second scan job,
the first specification operation, the second specification operation, the third specification operation, the first control operation, and the second control operation are executed in a case where an instruction to execute the first scan job is accepted, and
in a case where an instruction to execute the second scan job is accepted, the fourth specification operation, the fifth specification operation, and a sending operation of sending the scan job including the setting values specified in the fifth specification operation to the communication apparatus selected as the sending destination are executed.

14. The method of controlling an information processing apparatus according to claim 13, wherein the first scan job is a job of attaching a result of a scan executed by the communication apparatus to a file and sending the file to a predetermined destination, and the second scan job is a job of sending a result of a scan executed by the communication apparatus to the information processing apparatus.

15. The method of controlling an information processing apparatus according to claim 13, wherein
the method is configured to be capable of accepting the first scan job and the second scan job in a case where the communication apparatus selected as the sending destination is an electrophotographic image forming apparatus, and
the method is configured to be incapable of accepting the first scan job and capable of accepting the second scan job in a case where the communication apparatus selected as the sending destination is an inkjet image forming apparatus.

16. The method of controlling an information processing apparatus according to claim 12, wherein
the first specification operation, the second specification operation, the third specification operation, the first control operation, and the second control operation are executed in a case where the communication apparatus selected as the sending destination is an electrophotographic image forming apparatus, and
the fourth specification operation, the fifth specification operation, and a sending operation of sending the scan job including the setting values specified in the fifth specification operation to the communication apparatus selected as the sending destination are executed in a case where the communication apparatus selected as the sending destination is an inkjet image forming apparatus.

17. The method of controlling an information processing apparatus according to claim 1, wherein the information on the device model of the communication apparatus is a platform name of a firmware controller used in the communication apparatus.

18. The method of controlling an information processing apparatus according to claim 1, wherein
the first specification operation further specifies a plurality of setting values set for a plurality of setting items related to a copy job for causing the communication apparatus to execute copying or a fax job for causing the communication apparatus to execute faxing,
the third specification operation further specifies information on a device model of a communication apparatus selected as a destination to send the copy job or the fax job, and
the first control operation performs control not to display the predetermined notification screen for the copy job or the fax job.

19. An information processing apparatus comprising:
a first specification unit configured to specify a plurality of setting values set for a plurality of setting items related to a scan job for causing a communication apparatus to execute a scan;
a second specification unit configured to specify the setting value set for a particular setting item among the plurality of setting values;
a third specification unit configured to specify information on a device model of a communication apparatus selected as a destination to send the scan job;
a first control unit configured to perform control to display a predetermined notification screen based on a fact that the setting value set for the particular setting item is specified to be a first value and the information on the device model of the communication apparatus is specified to be information corresponding to a first device model, and perform control not to display the predetermined notification screen in a case where the setting value set for the particular setting item is specified to be the first value but the information on the device model of the communication apparatus is specified to be information corresponding to a second device model different from the first device model; and
a second control unit configured to perform control to send the scan job not including information on the particular setting item to the communication apparatus selected as the sending destination based on a fact that a first operation is performed on the predetermined notification screen, and perform control not to send the scan job to the communication apparatus selected as the sending destination based on a fact that a second operation different from the first operation is performed on the predetermined notification screen.

20. A non-transitory computer readable storage medium storing a program which causes a computer to execute:
performing a first specification operation of specifying a plurality of setting values set for a plurality of setting items related to a scan job for causing a communication apparatus to execute a scan;
performing a second specification operation of specifying the setting value set for a particular setting item among the plurality of setting values;
performing a third specification operation of specifying information on a device model of a communication apparatus selected as a destination to send the scan job;
performing a first control operation of performing control to display a predetermined notification screen based on a fact that the setting value set for the particular setting item is specified to be a first value and the information on the device model of the communication apparatus is specified to be information corresponding to a first device model, and performing control not to display the predetermined notification screen in a case where the setting value set for the particular setting item is specified to be the first value but the information on the device model of the communication apparatus is specified to be information corresponding to a second device model different from the first device model; and
performing a second control operation of performing control to send the scan job not including information on the particular setting item to the communication apparatus selected as the sending destination based on a fact that a first operation is performed on the predetermined notification screen, and performing control not to send the scan job to the communication apparatus selected as the sending destination based on a fact that a second operation different from the first operation is performed on the predetermined notification screen.
